(19) United States
(12) Patent Application Publication
(10) Pub. No.: US 2017/0203990 A1
(43) Pub. Date: Jul. 20, 2017

(54) PROCESS DECIDING METHOD IN METHOD OF MANUFACTURING OPTICAL ELEMENT, METHOD OF MANUFACTURING OPTICAL ELEMENT, AND OPTICAL ELEMENT

(71) Applicant: OLYMPUS CORPORATION, Tokyo (JP)

(72) Inventor: Naoyuki MORISADA, Tokyo (JP)

(73) Assignee: OLYMPUS CORPORATION, Tokyo (JP)

(21) Appl. No.: 15/476,637

(22) Filed: Mar. 31, 2017

Related U.S. Application Data
(63) Continuation of application No. PCT/JP2015/072201, filed on Aug. 5, 2015.

(30) Foreign Application Priority Data
Oct. 16, 2014 (JP) 2014-212001

(51) Int. Cl. C03B 11/00; G02B 3/00; C03B 11/05

(52) U.S. Cl. CPC C03B 11/005; C03B 11/05; G02B 3/00; C03B 2215/46

(57) ABSTRACT

A process deciding method in a method of manufacturing an optical element by heating and press-molding an optical material to mold the optical element using a molding die on which a release film is formed, includes a basicity degree identifying process in which a degree of basicity of the optical material is identified; and a removing process determining process of determining whether to perform one or both of first removing process in which an oxidizing substance is removed and a second removing process in which a basic substance is removed from at least one of a surface of the optical material and a surface of the release film by comparing the degree of basicity of the optical material identified in the basicity degree identifying process with a predetermined reference value, before press-molding the optical material.

This application is a continuation application based on a PCT International Application No. PCT/JP2015/072201, filed on Aug. 5, 2015, whose priority is claimed on Japanese Patent Application No. 2014-212001, filed on Oct. 16, 2014. The contents of both the PCT International Application and the Japanese Patent Application are incorporated herein by reference.

### BACKGROUND OF THE INVENTION

Field of the Invention

The present invention relates to a process deciding method in a method of manufacturing an optical element, a method of manufacturing an optical element, and an optical element.

Description of Related Art

According to the related art, a press-molding method of manufacturing an optical element is performed by arranging an optical material made of glass on a molding die having a molding surface on which an optical element is formed, heating, and pressing the optical material.

In such press-molding method, a release film including, for example, a noble metal, is formed on a molding surface of the molding die in order to satisfactorily release a molded article.

However, according to types and molding conditions of the optical material, a phenomenon in which a surface of the molded article becomes foggy and releasability deteriorates has occurred.

For example, in a molding method described in Japanese Unexamined Patent Application, First Publication No. 2006-111495, in order to suppress a reaction between components of a mold material and substances of a release film during molding, a method in which an oxide having low reactivity with respect to the mold material corresponding to a degree of basicity of the mold material of the molded article is used for the release film is proposed.

According to the technology described in Japanese Unexamined Patent Application, First Publication No. 2006-111495, even if molding is performed using a release film containing an oxide having low reactivity according to a mold material, defects such as fogging that occurs on a surface of a molded article are not all completely removed.

Such phenomena may be generated according to not only a reaction between an optical material and a release film but also a reaction between substances adhered to surfaces of a mold material and a release film and components of an optical material.

Types of substance adhered to the surfaces of the mold material and the release film are diverse, and methods of efficiently removing the substances are different. Therefore, when all adhesive materials are removed from the surfaces of the optical material and the release film, much time and effort is required for the removing process.

### SUMMARY OF THE INVENTION

According to a first aspect of the present invention, a process deciding method in a method of manufacturing an optical element by heating and press-molding an optical material to mold the optical element using a molding die on which a release film is formed, including: a basicity degree identifying process in which a degree of basicity of the optical material is identified; and a removing process determining process of determining whether to perform one or both of a first removing process in which an oxidizing substance is removed and a second removing process in which a basic substance is removed from at least one of a surface of the optical material and a surface of the release film by comparing the degree of basicity of the optical material identified in the basicity degree identifying process with a predetermined reference value, before pressing the optical material.

According to a second aspect of the present invention, a process deciding method in a method of manufacturing an optical element in by heating and press-molding an optical material to mold the optical element using a molding die on which a release film is formed is used, includes: a basicity degree identifying process in which a degree of basicity of the optical material is identified; and a removing process determining process of determining whether to perform one or both of a first removing process in which any of oxygen, ozone, fluorine, chlorine, bromine, and a manganese oxide is removed and a second removing process in which any of carbon, a carbon compound, aluminum, and an alkali metal is removed from at least one of a surface of the optical material and a surface of the release film by comparing the degree of basicity of the optical material identified in the basicity degree identifying process with a predetermined reference value, before pressing of the optical material starts.

According to a third aspect of the present invention, in the process deciding method according to the above-mentioned first aspect or the second aspect, in the removing process determining process, the reference value may be set to 0.53, and the first removing process may be determined to be performed when the degree of basicity of the optical material is equal to or more than the reference value, and the second removing process may be determined to be performed when the degree of basicity of the optical material is equal to or less than the reference value.

According to a fourth aspect of the present invention, a method of manufacturing an optical element by molding an optical material whose degree of basicity is equal to or less than 0.53 using a molding die on which a release film is formed, including: a removing process in which a basic substance is removed from at least one of a surface of the optical material and a surface of the release film; and a molding process in which the optical material is arranged on the molding die and is heated and press-molded.

According to a fifth aspect of the present invention, in the method of manufacturing an optical element according to the above-mentioned fourth aspect, a cleaning process in which at least one of surfaces of the optical material and the release film is cleaned using an organic solvent may be performed before the removing process is performed, and the removing process may include a process in which residues of the organic solvent are removed.

According to a sixth aspect of the present invention, a method of manufacturing an optical element by molding an optical material whose degree of basicity is equaled to or more than 0.53 using a molding die on which a release film is formed, including: a removing process in which an oxidizing substance is removed from at least one of a surface of the optical material and a surface of the release film; and a molding process in which the optical material is arranged on the molding die to be heated and press-molded.

According to a seventh aspect of the present invention, in the method of manufacturing an optical element according to the above-mentioned sixth aspect, the removing process may include a process of removing oxygen from surfaces of the optical material and the release film by setting an oxygen concentration in an atmosphere inside the molding die is set to equal to or less than 5 ppm, after the optical material is arranged on the molding die.

According to an eighth aspect of the present invention, an optical element manufactured by the method of manufacturing an optical element according to any one of the above-mentioned fourth aspect to the seventh aspect.

### BRIEF DESCRIPTION OF DRAWINGS

FIG. 1A is a schematic front view showing an example of an optical element manufactured by a method of manufacturing an optical element according to a first embodiment of the present invention.

FIG. 1B is a schematic plan view showing an example of an optical element manufactured by the method of manufacturing an optical element according to the first embodiment of the present invention.

FIG. 2 is a schematic cross-sectional view of a molding die and a molding device used in the method of manufacturing an optical element according to the first embodiment of the present invention.

FIG. 3 is a flowchart showing a flow of a process deciding method according to the first embodiment of the present invention.

FIG. 4 is a flowchart showing a flow of the method of manufacturing an optical element according to the first embodiment of the present invention.

FIG. 5 is a schematic process explanatory diagram of a removing process of the method of manufacturing an optical element according to the first embodiment of the present invention.

FIG. 6 is a schematic process explanatory diagram of a molding process of the method of manufacturing an optical element according to the first embodiment of the present invention.

FIG. 7A is a schematic process explanatory diagram of a removing process of a method of manufacturing an optical element according to a second embodiment of the present invention.

FIG. 7B is a schematic process explanatory diagram of a removing process of the method of manufacturing an optical element according to the second embodiment of the present invention.

### DETAILED DESCRIPTION OF THE INVENTION

Hereinafter, embodiments of the present invention will be described with reference to the accompanying drawings. In all drawings, even if embodiments are different, the same or corresponding elements are denoted by the same reference numerals and common descriptions will be omitted.

### First Embodiment

First, a molding device used in a method of manufacturing an optical element according to a first embodiment of the present invention and an optical element manufactured accordingly will be described.

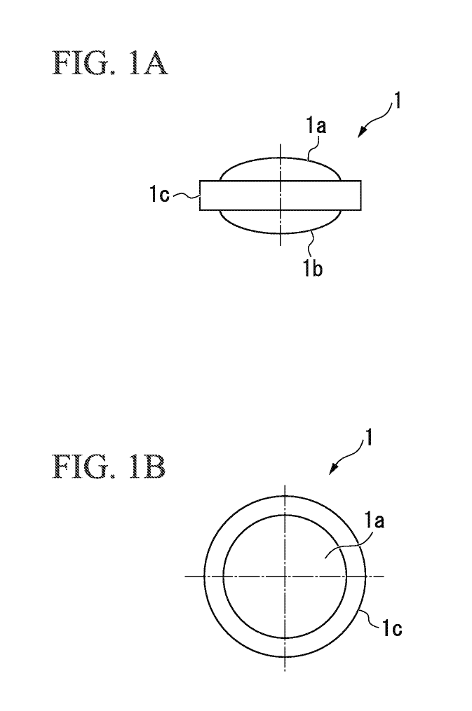

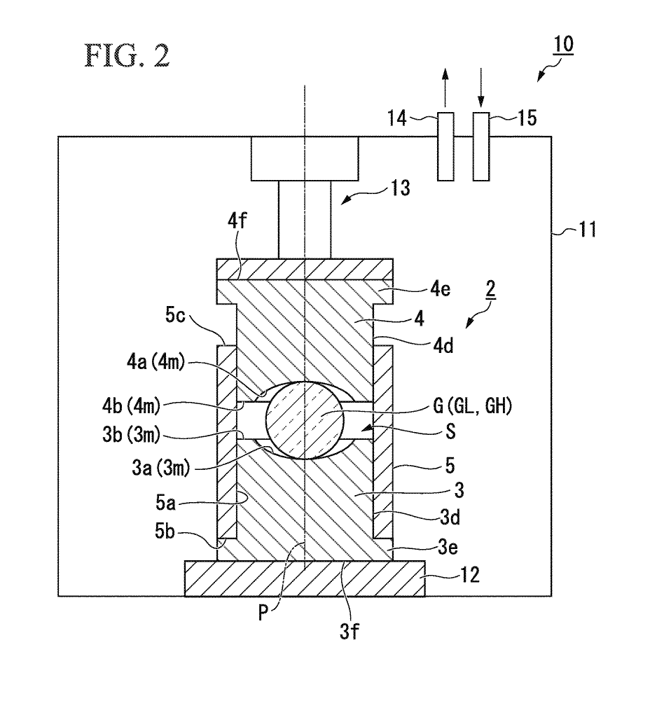

FIG. 1A and FIG. 1B are a schematic front view and a plan view showing an example of an optical element manufactured by the method of manufacturing an optical element according to the first embodiment of the present invention. FIG. 2 is a schematic cross-sectional view of a molding die and a molding device used in the method of manufacturing an optical element according to the first embodiment of the present invention.

The optical element manufactured by the method of manufacturing an optical element according to the present embodiment is not particularly limited as long as an outer shape of an optical element is formed by pressing a glass material. An optical element of an appropriate type, for example, a lens, a prism, a mirror, a filter, and a substrate, can be used. A surface of an effective optical area of the optical element may have a curvature, or a flat surface having no curvature may be used. When the surface of the effective optical area of the optical element has a curvature, a convex surface or a concave surface may be provided.

Hereinafter, as an example of an optical element according to the present embodiment, an example in which a lens 1 (an optical element) shown in FIG. 1A and FIG. 1B is molded will be described.

The lens 1 is a biconvex lens which is a single lens (one lens) molded from a glass material. The lens 1 includes a convex lens surface 1a and a convex lens surface 1b. The lens 1 has a shape in which a flange part 1c having a circular outer shape is provided on an outer circumference of the convex lens surfaces 1a and 1b.

The convex lens surfaces 1a and 1b are processed to surface shapes with surface accuracy based on design specifications of the lens 1. Film coating, for example, antireflection film coating or protective film coating can be performed on the convex lens surfaces 1a and 1b as necessary.

The lens 1 is manufactured by the method of manufacturing an optical element according to the present embodiment using an optical element molding die 2 (a molding die) and a molding device 10 shown in FIG. 2.

The optical element molding die 2 includes a lower mold 3, an upper mold 4, and a body mold 5 which are arranged such that central axis lines thereof are aligned with a central axis line P. Therefore, hereinafter, all of the central axis lines of the members of the optical element molding die 2 are referred to as the central axis line P.

The lower mold 3 includes a substantially columnar shape member that includes a side surface 3d having a cylindrical surface shape whose outer diameter is slightly larger than an outer diameter of the lens 1. In the lower mold 3, a lens surface molding surface 3a having a concave surface and a flat part molding surface 3b having a planar shape are formed. The lens surface molding surface 3a is a molding surface which is a first end (an upper end in FIG. 2) in an axial direction along the central axis line P of the lower mold 3 for transferring a shape of the convex lens surface 1b. The flat part molding surface 3b is a molding surface for transferring a shape of the flange part 1c adjacent to the convex lens surface 1b.

In a second end (a lower end in FIG. 2) in an axial direction of the lower mold 3, a flange part 3e that extends outward in a radial direction orthogonal to the central axis line P from the side surface 3d is formed. A lower end surface in an axial direction of the flange part 3e in FIG. 2 forms a lower surface 3f orthogonal to the central axis line P.

A base material of the lower mold 3 is a material, such as, a cemented carbide alloy whose main component is tungsten carbide (WC), a silicon carbide, and carbon, which have favorable heat resistance and high hardness.

The lens surface molding surface 3a and the flat part molding surface 3b are formed such that such a base material is processed into the shape of the convex lens surface 1b or a planar shape, and are formed by forming a thin film containing a noble metal as a release film.

A thin film used for the lens surface molding surface 3a and the flat part molding surface 3b contains a noble metal element that does not easily cause a chemical reaction with components of a glass material during molding so that the outermost surface in contact with the glass material during molding has favorable releasability. Hereinafter, the lens surface molding surface 3a and the flat part molding surface 3b will be collectively referred to as a release film part 3m (a release film) in some cases.

As the noble metal element contained in the thin film, an appropriate noble metal element can be used. As a particularly preferable element, at least one kind of element selected from among platinum (Pt), gold (Au), iridium (Ir), rhenium (Re), silver (Ag), osmium (Os), and tantalum (Ta), or combinations of two or more kinds thereof can be used.

Methods for forming a thin film include, for example, RF sputtering, magnetron sputtering, and ion beam sputtering.

The upper mold 4 includes a substantially columnar shape member having a side surface 4d having a cylindrical surface shape whose outer diameter is the same as that of the side surface 3d of the lower mold 3. In the upper mold 4, a lens surface molding surface 4a having a concave surface and a flat part molding surface 4b having a planar shape are formed. The lens surface molding surface 4a is a molding surface which is one end (a lower end in FIG. 2) in an axial direction along the central axis line P of the upper mold 4 for transferring a shape of the convex lens surface 1a. The flat part molding surface 4b is a molding surface for transferring a shape of the flange part 1c adjacent to the convex lens surface 1a.

At an upper end in an axial direction of the upper mold 4 in FIG. 2, a flange part 4e that extends outward in a radial direction orthogonal to the central axis line P from the side surface 4d is formed. An upper end surface in an axial direction of the flange part 4e in FIG. 2 forms an upper surface 4f orthogonal to the central axis line P.

After an outer shape of the upper mold 4 having such a configuration is formed using the same material as the base material of the lower mold 3, the same release film as in the lower mold 3 is then formed, whereby the lens surface molding surface 4a and the flat part molding surface 4b are formed. Hereinafter, the lens surface molding surface 4a and the flat part molding surface 4b will be collectively referred to as a release film part 4m (a release film).

The body mold 5 is a cylindrical member having an inner circumferential surface 5a. The inner circumferential surface 5a is slidably fitted around the side surface 3d of the lower mold 3 and the side surface 4d of the upper mold 4. A lower surface 5b and an upper surface 5c which are both ends of the body mold 5 in an axial direction include a flat surface orthogonal to the central axis line P of the inner circumferential surface 5a.

A length of the body mold 5 in an axial direction (a distance from the lower surface 5b to the upper surface 5c) is shorter than a distance between the flange parts 3e and 4e when the optical element molding die 2 is assembled, which will be described below.

In such a configuration, while glass is molded, the body mold 5 maintains a coaxial positional relationship between the lower mold 3 and the upper mold 4 and can moveably guide the upper mold 4 along the central axis line P.

In the present embodiment, since the body mold 5 is not a molding surface on which a side surface of the flange part 1c is molded, it can be made of an appropriate metal material or ceramic having heat resistance at a molding temperature.

In the present embodiment, as an example, a cemented carbide alloy having favorable heat resistance and high hardness is used.

The optical element molding die 2 is assembled such that the body mold 5 is fitted around the side surface 3d of the lower mold 3, glass G (an optical material) weighed to a mass necessary for molding is arranged on the lens surface molding surface 3a, and the upper mold 4 is inserted from above the body mold 5.

In this assembly, the glass G is accommodated inside a molding space S surrounded by the lens surface molding surfaces 3a and 4a, the flat part molding surfaces 3b and 4b, and the body mold 5.

The molding space S communicates with the outside through a gap between each of the lower mold 3 and the upper mold 4 and the body mold 5 or a through hole (not shown) provided in the body mold 5 in some cases.

The assembly of the optical element molding die 2 including the glass G is arranged inside the molding device 10 and is used for molding the lens 1.

A shape of the glass G is drawn in, for example, a spherical shape, in FIG. 2. The shape of the glass G is not limited to a spherical shape as long as the shape can be formed by pressing using the optical element molding die 2. As the shape of the glass G, in addition to a spherical shape, shapes such as a disc shape, a spheroid shape, and a shape similar to that of the lens 1, can be appropriately used.

The molding device 10 includes a vacuum chamber 11, a heating stage 12 and a pressing part 13. The optical element molding die 2 accommodates the vacuum chamber 11 therein. The heating stage 12 heats the optical element molding die 2 from below. The pressing part 13 presses the optical element molding die 2 placed on the heating stage 12 while heat is applied from above.

In the vacuum chamber 11, a suction pipe line 14 connected to a vacuum pump and an inert gas supply pipe line 15 connected to an inert gas supply source are provided such that a low oxygen atmosphere or an inert gas atmosphere can be maintained inside as necessary.

In the molding device 10, the optical element molding die 2 is arranged on a placement surface of the heating stage 12 while the lower surface 3f of the lower mold 3 faces downward in an orientation in which the central axis line P thereof is in a vertical direction.

Next, a process deciding method in a method of manufacturing an optical element according to the present embodiment and a method of manufacturing an optical element will be described.

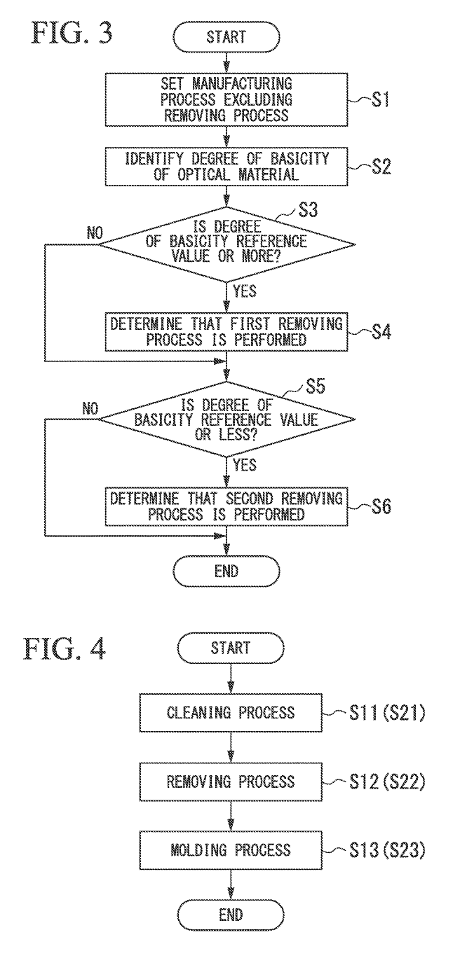

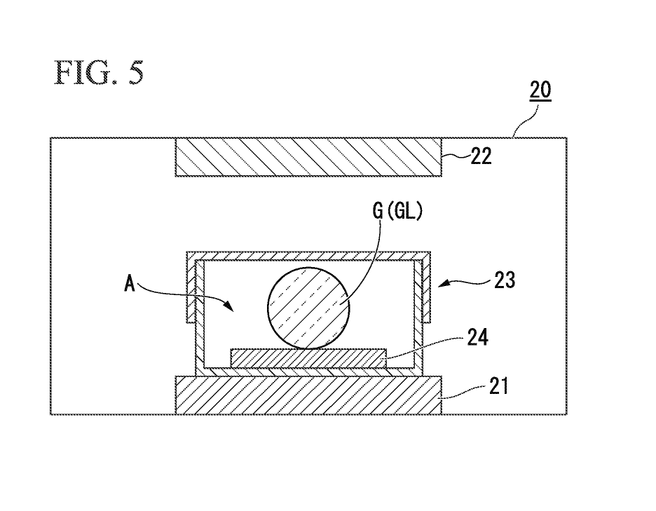

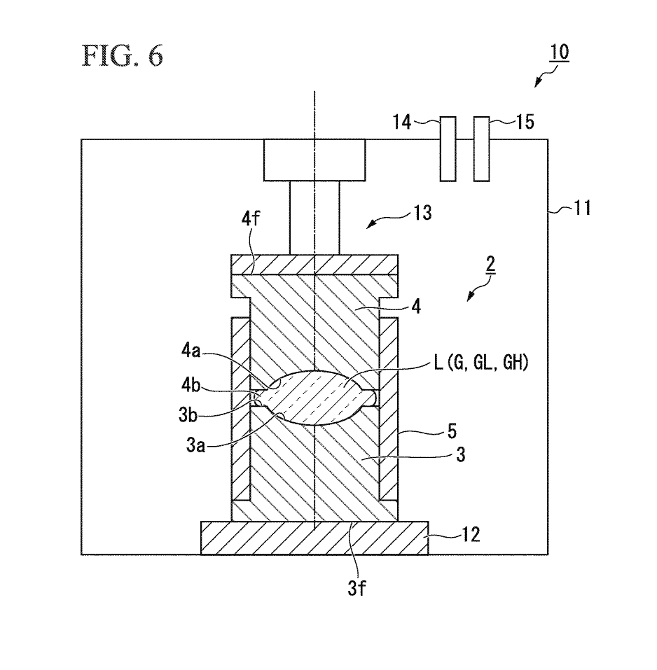

FIG. 3 is a flowchart showing a flow of the process deciding method according to the present embodiment. FIG. 4 is a flowchart showing a flow of the method of manufacturing an optical element according to the present embodiment. FIG. 5 is a schematic process explanatory diagram of a removing process of the method of manufacturing an optical element according to the present embodiment. FIG. 6 is a schematic process explanatory diagram of a molding process of the method of manufacturing an optical element according to the present embodiment.

The method of manufacturing an optical element according to the present embodiment includes a manufacturing process for minimizing defects occurring during press-molding due to substances remaining on at least one of a surface of an optical material and a surface of a release film. Specifically, before press-molding, a removing process is performed in which, among substances remaining on a surface of an optical material and a surface of a release film, a substance that easily causes defects is removed from at least one of the surface of the optical material and the surface of the release film.

In the removing process, the substance to be removed differs depending on material properties of the glass G. Therefore, a removing process to be performed is decided by the process deciding method according to the present embodiment.

The process deciding method may be performed at any time as long as the method is performed before an optical element is initially molded using predetermined glass G.

Before a specific flow of the process deciding method according to the present embodiment is described, principles of process decision will be described.

Seizing and fogging of a molded article are known as defects occurring when glass is press-molded.

Seizing refers to a phenomenon in which a part of a surface of a molded article is firmly fixed to a release film so that it is not possible to release the molded article, and even if it is possible to release the molded article, a glass material peels off from the surface of the molded article and is fixed to the release film.

For a release film on the molding die, in general, a material that does not cause seizing is selected according to a material of the glass G. However, regardless of the material, seizing may be caused.

Seizing is considered to be caused when the glass G and the release film fuse due to a substance (hereinafter referred to as a residual substance) itself different from the glass G remaining on a surface of the glass G or a surface of the release film or a reaction product of the residual substance and the glass G.

Fogging of the molded article is a defect on a surface of a molded article that is caused by, for example, a change in an amount of transmitted light with respect to an amount of transmitted light of a normal part, and that can be visually observed. When observation is performed under a microscope, this shows that fine foreign matter adheres to a surface of the molded article and fine holes are formed.

Fogging of the molded article is considered to be caused when a residual substance adheres to a surface of the glass G or a surface of the release film, the residual substance causes an interaction such a chemical reaction with a glass component during molding, fine foreign matter is generated, and fine holes are formed.

However, in such defects, since a substance present on a surface of the molded article and a surface of the release film after molding does not necessarily match a residual substance of each of the surfaces before molding, it is not easy to identify a residual substance that causes such defects.

The inventor conducted various experiments by changing the type of the residual substance when glass is press-molded, and found that a degree of basicity of the glass G and chemical properties of the residual substance are related to occurrence of defects.

That is, when a degree of basicity of the glass G is a certain reference value or more, a defect due to an oxidizing substance contained in the residual substance significantly occurs. On the other hand, when a degree of basicity of the glass G is a reference value or less, a defect due to a basic substance contained in the residual substance significantly occurs.

As an example of the oxidizing substance, for example, oxygen, ozone, fluorine, chlorine, bromine, and a manganese oxide can be given as an example. It is considered that a substance among the above-mentioned oxidizing substances which is exist in a gas state adheres to a surface of the glass G or a surface of the release film, when a concentration thereof in an atmosphere during molding is equal to or more than a certain concentration.

As an example of the basic substance, for example, carbon, a carbon compound, aluminum, and an alkali metal can be given as an example. In particular, for example, when an organic solvent is used to clean a surface of the glass G or the release film, it is considered that some of the carbon compound may remain and adhere to a surface of the glass G or a surface of the release film.

Next, an example of the process deciding method according to the present embodiment will be described.

The process deciding method according to the present embodiment is a method in which Steps S1 to S6 shown in FIG. 3 are performed according to the flowchart shown in FIG. 3.

Step S1 is a step in which all manufacturing processes excluding a removing process in the method of manufacturing an optical element according to the present embodiment are set.

In this step, for example, conditions in processes such as a molding process of the glass G, a cleaning process of the glass G, and a molding process of the glass G using the molding device 10 are set.

When conditions of the molding process of the glass G are set, conditions such as whether to form the glass G by molding from a base material, or by cutting from a base material, whether to form it oneself, or buy it as a product are investigated and are determined case by case.

When conditions of the cleaning process of the glass G are set, conditions of the necessary cleaning and drying processes are set according to, for example, a molding method of the glass G and a degree of contamination that can occur. Cleaning of an aqueous system and cleaning using an organic solvent are generally performed for cleaning.

When conditions of the molding process of the glass G are set, for example, molding conditions and conditions for maintenance such as cleaning of a molding die performed as necessary are set.

Next, Step S2 is performed. This step is a step in which a degree of basicity of the glass G which is an optical material is identified and constitutes a basicity degree identifying process of the process deciding method according to the present embodiment.

A degree of basicity of the glass G may be identified and measured using a method which is experimentally obtained or may be identified by calculating it based on a composition of the glass G.

In the present embodiment, an example in which a degree of basicity is identified by calculating it based on a composition of the glass G will be described. Specifically, a degree of basicity Λ(χ) is obtained using the following Equations (1) and (2) proposed by Duffy and Ingram.

$$\begin{matrix}[ Math . 1 ] & \\ Λ ( χ ) = {\sum }_{i} \frac{{z}_{i} {r}_{i}}{2 {γ}_{i}} & ( 1 ) \\ {γ}_{i} = 1.36 ( {χ}_{i} - 0.26 ) & ( 2 )\end{matrix}$$

Here, the summation sign refers to a sum for all types of cation i. Zᵢ denotes the valence of a type of cation i contained in the glass G, rᵢ denotes the number of cations of type i per oxygen atom contained in the glass G, γᵢ denotes the reciprocal of an optical basicity degree of a simple oxide, and χᵢ denotes the electronegativity of a type of cation i.

Note that rᵢ is calculated by the following Equation (3) when a type of oxide i is expressed as MₘᵢOₘᵢ and the number of moles or a mole fraction of the type of oxide i is expressed as xᵢ.

$$\begin{matrix}[ Math . 2 ] & \\ {r}_{i} = \frac{{x}_{i} \times {m}_{i}}{{\sum }_{i} ( {x}_{i} \times {n}_{i} )} & ( 3 )\end{matrix}$$

When the degree of basicity Λ(χ) is computed by Equation (1), first, an oxide composition of the glass G is obtained by analysis or the like.

As a method of measuring an oxide composition of the glass G, analytical methods using, for example, energy dispersive X-ray spectrometry (EDS), an electron probe microanalyzer (EPMA), and an inductively coupled plasma (ICP), can be given as an example.

For example, when the glass G is optical glass L-BBH1 (product name; commercially available from OHARA Inc), oxides and mole fractions expressed as (MₘᵢOₙᵢ, xᵢ), (SiO₂, 0.104), (B₂O₃, 0.194), (ZnO, 0.0794), (Bi₂O₃, 0.473), (CaO, 0.0505), (SrO, 0.0256), (BaO, 0.0286), and (TeO₂, 0.0449) are obtained.

zᵢ and χᵢ of cations are known, xᵢ is obtained by the above measurement, and rᵢ and γᵢ are obtained by Equations (3) and (2). By assigning these values to Equation (1), the degree of basicity Λ(χ) is computed.

For example, in case of L-BBH1, Λ(χ)=0.47 is identified.

In the same manner, it is possible to identify the degree of basicity Λ(χ) of various optical glasses. For example, L-BBH2 (product name; commercially available from OHARA Inc) has Λ(χ)=0.45, MP-200 (product name; commercially available from Nippon Electric Glass Co., Ltd.) has Λ(χ)=0.44, and L-LAH53 (product name; commercially available from OHARA Inc) has Λ(χ)=0.55.

When the degree of basicity Λ(χ) of the glass G used for molding is identified, Step S2 ends.

Next, Step S3 is performed. This step is a comparison step in which it is determined whether the degree of basicity Λ(χ) identified in Step S2 is a reference value Λ₀ or more.

According to the results of various experiments that the inventor performed, a degree of basicity serving as a reference value at which the manner of occurrence of defects changed according to whether a residual substance was an oxidizing substance or a basic substance was about 0.53.

Therefore, in the present embodiment, Λ₀=0.53 is used as the reference value Λ₀.

When the degree of basicity Λ(χ) is the reference value Λ₀ or more, the process advances to Step S4.

When the degree of basicity Λ(χ) is less than the reference value Λ₀, the process advances to Step S5.

Step S4 is a step in which it is determined that a first removing process is to be performed as the removing process according to the result determined as Λ(χ)≧Λ₀ in Step S3.

The first removing process is a removing process in which an oxidizing substance is removed from at least one of a surface of the glass G and surfaces of the release film parts 3m and 4m.

For a specific removing method, in specific molding conditions, an oxidizing substance that may remain on a surface of the glass G and surfaces of the release film parts 3m and 4m is investigated in advance, and a suitable removing method is set according to a type of the oxidizing substance.

Also, when it is known that an oxidizing substance causing defects does not remain on any of a surface of the glass G and surfaces of the release film parts 3m and 4m or does not remain to the extent at which defects occur, it is possible to set the removing process not to be performed on the surface.

The removing method is not particularly limited as long as no obstacles occur during molding in the removing method, and it is possible to appropriately select one or more removing methods from among known removing methods.

When a required removing method is selected, Step S4 ends, and the process advances to Step S5.

As the removing method used for the first removing process, a removing method in which, if the oxidizing substance is a gas, for example, oxygen, ozone, fluorine, or chlorine, when the optical element molding die 2 is arranged inside the vacuum chamber 11, concentrations of gases remaining inside the optical element molding die 2 are reduced can be used.

As gas concentrations of gases that are removed from a surface of the glass G and surfaces of the release film parts 3m and 4m, concentrations at which defects do not occur when molding is performed may be experimentally obtained by changing a gas concentration.

For example, when the oxidizing substance is oxygen, it is possible to minimize the occurrence of defects as long as the oxygen concentration is 5 ppm.

In press-molding of glass, when a non-oxidizing atmosphere during molding is formed in order to minimize oxidization of a molding die or a release film part, the oxygen concentration is set to about 10 ppm to 60 ppm regardless of the type of the glass G in the related art.

Accordingly, in the present embodiment, according to a degree of basicity of the glass G, in order to minimize defects due to a residual substance, an oxygen concentration is set to be lower than in a non-oxidizing atmosphere of the related art.

In such a removing method, concentrations of gases are the same in the vicinity of the glass G and the vicinity of the release film parts 3m and 4m, since gases are removed from a surface of the glass G and surfaces of the release film parts 3m and 4m.

As another example of the removing method used for the first removing process, for example, when the oxidizing substance is liquid bromine, a removing method in which the assembly of the optical element molding die 2 including the glass G described above is heated at a boiling point of bromine or higher, bromine is converted into gas, an inert gas (nitrogen gas) passes through a vacuum chamber, and the converted bromine is removed together with the inert gas can be used.

When the oxidizing substance is, for example, a manganese oxide, a removing method such as cleaning using a particle cleaning agent for a lens and a glass substrate can be used.

Step S5 is a comparison step in which it is determined whether the degree of basicity Λ(χ) identified in Step S2 is the reference value Λ₀ or less.

When the degree of basicity Λ(χ) is the reference value Λ₀ or less, the process advances to Step S6.

When the degree of basicity Λ(χ) exceeds the reference value Λ₀, the process decision is completed accordingly.

Step S6 is a step in which it is determined that a second removing process is to be performed as the removing process according to the result determined as Λ(≦)≦Λ₀ in Step S5.

The second removing process is a removing process in which a basic substance is removed from at least one of a surface of the glass G and surfaces of the release film parts 3m and 4m.

For a specific removing method, in specific molding conditions, a basic substance that may remain on a surface of the glass G and surfaces of the release film parts 3m and 4m is investigated in advance, and a suitable removing method is set according to the type of the basic substance.

Also, when it is known that a basic substance causing defects does not remain on any of a surface of the glass G and surfaces of the release film parts 3m and 4m or does not remain to the extent at which defects occur, it is possible to set the removing process not to be performed on the surface.

The removing method is not particularly limited as long as no obstacles occur during molding in the removing method, and it is possible to appropriately select one or more removing methods from among known removing methods.

When a required removing method is selected, Step S6 ends and the process decision is completed accordingly.

In order to investigate a basic substance serving as a residual substance, for example, it is sufficient to examine a substance adhered to a surface of the glass G and surfaces of the release film parts 3m and 4m immediately before press-molding when specific conditions of a manufacturing process of the lens 1 are set.

As an examination method, for example, X-ray photoelectron spectroscopy (XPS), secondary ion mass spectrometry (SIMS), energy dispersive X-ray spectrometry (EDS), fluorescence measurement, and contact angle measurement can be given as an example.

As the removing method used for the second removing process, so-called dry cleaning can be used when the basic substance is, for example, an organic carbon compound.

As an example of the carbon compound, organic substances contained in various organic solvents can be given as an example.

Hereinafter, as an example of dry cleaning, a removing method that is particularly suitable for a residual substance including a carbon compound contained in an organic solvent is given as an example.

For example, a heat treatment in the presence of oxygen is possible. Specifically, a treatment in which a processing target is heated at 300° C. for 30 minutes is possible.

A heat treatment under a vacuum atmosphere is possible. Specifically, a treatment in which a processing target is heated at 200° C. for 15 minutes in a heating furnace that is evacuated to about 10⁻² Pa is suitable.

A plasma treatment is possible. Specifically, a treatment in which an atmospheric plasma device is used and plasma is emitted toward a processing target for 30 seconds is possible.

An ultraviolet (UV) emission treatment is possible. Specifically, a treatment in which an excimer lamp using xenon (Xe) gas is used and ultraviolet rays of a wavelength of 172 nm are emitted toward a processing target for 30 seconds is possible.

A treatment in which plasma and water vapor are emitted together is possible. Specifically, a treatment in which water vapor is generated by heating using an electric heater, plasma is emitted toward the generated water vapor, OH radicals are generated, and plasma and OH radicals are emitted toward a processing target is possible.

In such removing methods, methods in which the glass G and the release film parts 3m and 4m can be simultaneously and individually treated as processing targets are provided. Therefore, one or more removing methods are selected according to characteristics of the removing methods, and it is possible to remove a basic substance from at least one of a surface of the glass G and surfaces of the release film parts 3m and 4m.

As another removing method used for the second removing process, pre-annealing can be given as an example when the basic substance is, for example, carbon (such as charcoal, graphite, and glassy carbon). As pre-annealing conditions, for example, heating using an electric furnace or the like under an air atmosphere at 400° C. for 2 hours is suitable.

When the basic substance is aluminum or a metal such as an alkali metal, it is possible to use a removing method such as wet cleaning using hydrochloric acid and hydrogen peroxide.

Steps S3 to S6 constitute a removing process determining process in which the degree of basicity Λ(χ) of the glass G identified in Step S2 is compared with the reference value Λ₀, and it is determined whether the first removing process or the second removing process is performed before pressing of the glass G starts.

By performing such a process deciding method, the manufacturing process of the method of manufacturing an optical element according to the present embodiment for manufacturing the lens 1 is decided.

According to the process deciding method in the present embodiment, it is possible to decide a removing process through which only a residual substance which should be removed because it causes defects is efficiently removed by a simple method in which a degree of basicity of the glass G is compared with a reference value. Therefore, it is possible to easily decide a process for minimizing defects occurring due to a substance remaining on a surface of the optical material or the release film when press-molding is performed.

Next, the method of manufacturing an optical element according to the present embodiment will be described.

The present embodiment is an example in which glass GL whose degree of basicity Λ(χ) is less than the reference value Λ₀ is used as the glass G and the lens 1 is manufactured by press-molding.

As an example of the glass GL, for example, L-BBH2 can be given as an example.

In the present embodiment, a molding process of the glass GL may be included. However, as an example, an example in which glass GL formed into a shape that can be press-molded using the molding device 10 has already been prepared will be described below.

Therefore, the manufacturing processes of the lens 1 decided in the process deciding process are Steps S11 to S13 shown in FIG. 4. The method of manufacturing an optical element according to the present embodiment is a method in which Steps S11 to S13 are performed according to the flowchart of FIG. 4.

Step S11 is a step constituting a cleaning process in which the glass G (GL) is cleaned.

In this step, for example, the glass GL is cleaned using a cleaning agent of an aqueous system, dried, and additionally cleaned using an organic solvent, the organic solvent is wiped off and the result is dried.

As the organic solvent, for example, isopropyl alcohol can be used.

Finally, Step S11 ends.

Next, Step S12 is performed. This step is a step constituting a removing process. Since the degree of basicity Λ(χ) of the glass GL is less than the reference value Λ₀, only the second removing process is set as the removing process.

Although dirt components on a surface of the glass GL are removed in Step S11, a small amount of a carbon compound may remain on the surface even when the organic solvent is wiped off.

The second removing process is performed to remove such a carbon compound residual substance from the surface of the glass GL.

In the present embodiment, as an example, a heat treatment in the presence of oxygen is set. For example, as shown in FIG. 5, the glass GL cleaned in Step S11 is placed on a support table part 21 inside a heating furnace 20 while being placed on a plate 24 made of alumina and accommodated in a glass Petri dish 23. An air atmosphere A is maintained inside of the heating furnace 20 and the glass Petri dish 23.

Heating conditions of the heating furnace include, for example, heating at 300° C. for about 30 minutes.

Accordingly, since the carbon compound is oxidized and volatilized from the surface of the glass GL, it is removed from the surface of the glass GL.

Finally, Step S12 ends.

Next, Step S13 is performed. This step is a step constituting a molding process in which the glass G(GL) is press-molded by the optical element molding die 2 and the molding device 10 and the lens 1 is manufactured.

The optical element molding die 2 is assembled while the glass GL from which the carbon compound residual substance is removed in Step S12 is interposed between the lens surface molding surface 3a of the lower mold 3 and the lens surface molding surface 4a of the upper mold 4 as shown in FIG. 2.

This assembly is arranged on the heating stage 12 in the vacuum chamber 11.

Then, an oxygen concentration and an atmosphere inside the vacuum chamber 11 are adjusted based on the set molding conditions. In the present embodiment, since the degree of basicity Λ(χ) of the glass GL is less than the reference value Λ₀, the oxygen concentration does not particularly influence occurrence of defects. Therefore, an atmosphere is adjusted such that the oxygen concentration is about 100 ppm so that members and molds constituting the inside of the molding device do not deteriorate at a temperature during molding.

Next, based on the set molding conditions, a temperature of the heating stage 12 is increased to a molding temperature. When the glass GL is heated to a moldable temperature, the pressing part 13 is lowered, the upper surface 4f of the upper mold 4 is pressed, and the heated glass GL is pressed.

For example, when the glass GL is L-BBH2, the glass GL is pressed while being heated to 450° C.

Accordingly, the softened glass GL is deformed along shapes of the lens surface molding surfaces 3a and 4a and the flat part molding surfaces 3b and 4b.

As shown in FIG. 6, when an interval between the lens surface molding surfaces 3a and 4a reaches an interval corresponding to an interplanar spacing of the lens 1, the lowering of the pressing part 13 stops. After a certain time has elapsed, heating using the heating stage 12 stops and cooling is performed.

Accordingly, a molded article L in which the glass GL is solidified and shapes of the lens surface molding surfaces 3a and 4a and the flat part molding surfaces 3b and 4b are transferred is formed.

The molded article L is demolded by removing the optical element molding die 2 from the vacuum chamber 11.

Accordingly, Step S13 ends.

In Step S13, the glass GL is pressed against the lens surface molding surfaces 3a and 4a and the flat part molding surfaces 3b and 4b while being heated. Therefore, when a residual substance different from the glass GL is interposed between the glass GL and the lens surface molding surfaces 3a and 4a and the flat part molding surfaces 3b and 4b, a reaction causing fogging and glass fusion is likely to occur.

However, in the present embodiment, in Step S12, since the basic substance is removed from the surface of the glass GL, a reaction causing fogging and glass fusion is suppressed, and molding can be performed without causing such defects.

In the molded article L demolded from the optical element molding die 2, a shape of an outer circumferential portion serving as the flange part 1c is processed according to, for example, grinding, as necessary.

In this manner, it is possible to manufacture the lens 1 shown in FIG. 1A and FIG. 1B without occurrence of defects such as fogging and seizing.

### Second Embodiment

Next, a method of manufacturing an optical element according to a second embodiment of the present invention will be described.

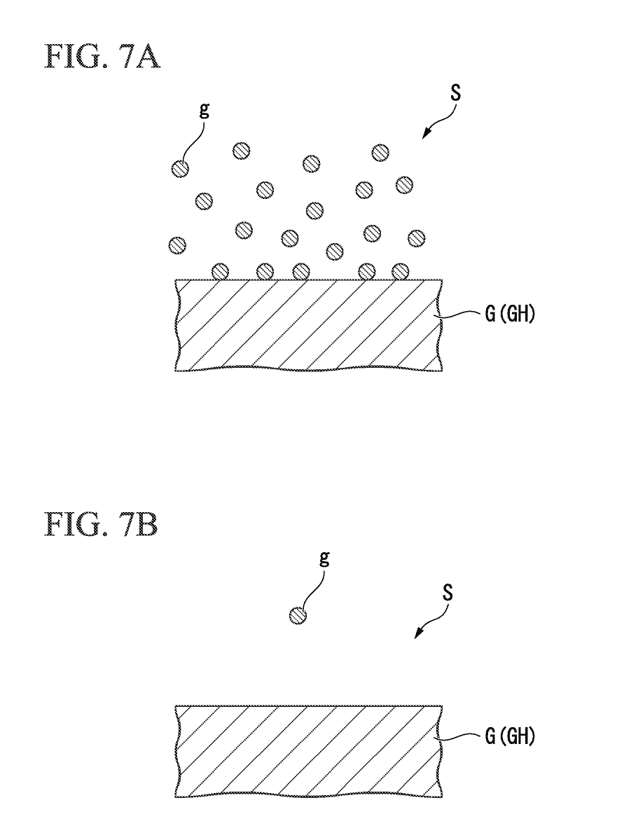

FIG. 7A and FIG. 7B are schematic process explanatory diagrams of the removing process of the method of manufacturing an optical element according to the second embodiment of the present invention.

The method of manufacturing an optical element according to the present embodiment is an example in which glass GH whose degree of basicity Λ(χ) exceeds the reference value Λ₀ is used as the glass G and the lens 1 is manufactured.

Therefore, the present embodiment is different from the first embodiment in that the first removing process is performed as the removing process, while the second removing process is performed as the removing process in the method of manufacturing an optical element according to the first embodiment.

Hereinafter, points different from those of the first embodiment will be mainly described.

In the present embodiment, as an example of the glass GH, for example, L-LAH53 can be given as an example.

In the present embodiment, a molding process of the glass GH may be included. However, as an example, an example in which glass GH formed into a shape that can be press-molded using the molding device 10 has already been prepared will be described below.

Therefore, the manufacturing processes of the lens 1 decided in the process deciding method according to the first embodiment are Steps S21 to S23 shown in FIG. 4. The method of manufacturing an optical element according to the present embodiment is a method in which Steps S21 to S23 are performed according to the flowchart of FIG. 4.

Step S21 is the same as Step S11 in the first embodiment except that the glass GH is used as the glass G.

Next, Step S22 is performed. This step is a step constituting a removing process. Since the degree of basicity Λ(χ) of the glass GH exceeds the reference value Λ₀, only the first removing process is set as the removing process.

A treatment in the first removing process can be selected according to the type of oxidizing substance that may be interposed between a surface of the glass GH and the release film parts 3m and 4m during press-molding. However, in the present embodiment, as an example, an example in which oxygen is removed will be described.

First, the optical element molding die 2 is assembled while the glass GH cleaned in Step S21 is interposed between the lens surface molding surface 3a of the lower mold 3 and the lens surface molding surface 4a of the upper mold 4 as shown in FIG. 2.

The assembly is arranged on the heating stage 12 inside the vacuum chamber 11.

In this state, as schematically shown in FIG. 7A, for example, various gas molecules g containing oxygen molecules are present in the vicinity of the glass GH in the molding space S and substantially a certain amount of gas molecules g adhere to a surface of the glass G. Here, “a state in which substantially a certain amount of gas molecules g adhere” means a state in which the number of gas molecules g adhered to the surface is in dynamic equilibrium.

The number of gas molecules g adhered to the surface of the glass GH decreases as the molding space S is depressurized. For example, when the oxygen concentration is about 10 ppm, a sufficient number of oxygen molecules to cause seizing or the like during press-molding adhere to the glass GH.

Although not shown, similarly, substantially a certain amount of gas molecules g also adhere to the release film parts 3m and 4m.

In this case, in the heating stage 12, although it is not necessary to increase a temperature always, it is possible to heat the glass GH to a temperature that does not exceed a molding temperature. In this case, it is possible to reduce a time required for heating in Step S22, and it is possible to perform rapid molding in the next step. It is possible to volatilize a substance having a low boiling point which adheres to a surface of the glass GH and surfaces of the release film parts 3m and 4m. A kinetic energy of the gas molecules g increases and thus the gas molecules g are easily separated from the surface of the glass GH, which is more preferable.

Next, while the inert gas supply pipe line 15 is closed, evacuation is performed from the suction pipe line 14, and an oxygen concentration inside the molding space S of the optical element molding die 2 is set to a predetermined concentration or less. In the present embodiment, evacuation is performed until the oxygen concentration becomes 5 ppm or less.

Accordingly, as shown in FIG. 7B, the number of gas molecules g in the vicinity of the surface of the glass GH is reduced, there are substantially no gas molecules g adhered to the surface of the glass GH, and gas molecules g containing oxygen molecules are removed from the surface of the glass GH.

Finally, Step S22 ends.

Next, Step S23 is performed. This step is the same as Step S13 according to the first embodiment except that the glass GH is used as the glass G, and there is no need to newly arrange the assembly of the optical element molding die 2 including the glass GH because it has already been arranged on the heating stage 12.

First, based on the set molding conditions, an oxygen concentration and an atmosphere inside the vacuum chamber 11 are adjusted. In the present embodiment, the oxygen concentration remains as the same oxygen concentration in Step S22. However, when increasing of a pressure inside the vacuum chamber 11 is preferable, it is possible to increase the pressure to an appropriate degree by supplying an inert gas from the inert gas supply pipe line 15.

Next, based on the set molding conditions, when a temperature of the heating stage 12 increases to a molding temperature and the glass G is heated to a moldable temperature, the pressing part 13 is lowered, the upper surface 4f of the upper mold 4 is pressed, and the heated glass GH is pressed.

For example, when the glass GH is L-LAH53, the glass GH is pressed while being heated to 620° C.

Accordingly, the softened glass GH is deformed along shapes of the lens surface molding surfaces 3a and 4a and the flat part molding surfaces 3b and 4b.

As shown in FIG. 6, when an interval between the lens surface molding surfaces 3a and 4a reaches an interval corresponding to an interplanar spacing of the lens 1, the lowering of the pressing part 13 stops. After a certain time has elapsed, heating using the heating stage 12 stops and cooling is performed.

Accordingly, a molded article L in which the glass GH is solidified and shapes of the lens surface molding surfaces 3a and 4a and the flat part molding surfaces 3b and 4b are transferred is formed.

The molded article L is demolded by removing the optical element molding die 2 from the vacuum chamber 11.

Accordingly, Step S33 ends.

In Step S33, the glass GH is pressed against the lens surface molding surfaces 3a and 4a and the flat part molding surfaces 3b and 4b while being heated. Therefore, when a residual substance different from the glass GH is interposed between the glass GH and the lens surface molding surfaces 3a and 4a and the flat part molding surfaces 3b and 4b, a reaction causing fogging and glass fusion is likely to occur.

In the present embodiment, in Step S22, since an oxidizing substance is removed from the surface of the glass GH, a reaction causing fogging and glass fusion is suppressed, and molding can be performed without causing such defects.

While the process deciding method in the first embodiment has been described based on the flowchart shown in FIG. 3, the performance order can be appropriately changed as long as Step S2 is performed before Steps S3 to S6. For example, the performance order of a group of Steps S3 and S4 and a group of Steps S5 and S6 can be changed. In Step S1, if the type of optical material is determined before Step S2, a timing at which other manufacturing processes are set is not particularly limited.

While an example in which the degree of basicity Λ(χ) of the glass G is less than the reference value Λ₀ or exceeds the reference value Λ₀ has been described in the embodiments, when Λ(χ)=Λ₀ is satisfied, the first removing process and the second removing process are performed as the removing process.

The Glass G formed with a degree of basicity of the reference value Λ₀ does not easily react with an oxidizing substance or a basic substance. Therefore, when Λ(χ)=Λ₀ is satisfied, it is possible to set the first removing process and the second removing process not to be performed, or it is possible to set either of the first removing process and the second removing process to be performed as the removing process.

An example in which one reference value Λ₀ is set has been described in the embodiments. However, when a degree of basicity is identified, the reference value Λ₀ can be set with a width in consideration of a certain degree of errors that are predicted.

For example, Λ₁ and Λ₂ (where, Λ₁<Λ₂) may be set as reference values. It is possible to determine that only the second removing process will be performed when the degree of basicity Λ(χ) of the glass G is less than Λ₁, the first removing process and the second removing process will be performed when the degree of basicity Λ(χ) of the glass G is Λ₁ or more and Λ₂ or less, and only the first removing process will be performed when the degree of basicity Λ(χ) of the glass G exceeds Λ₂.

All of the components described above can be implemented by appropriately combining or deleting them within the spirit and scope of the present invention.

### EXAMPLES

Hereinafter, examples of the method of manufacturing an optical element according to the first embodiment and the second embodiment will be described together with comparative examples.

All manufacturing processes of the examples are set based on the process deciding method according to the first embodiment. In this case, the reference value Λ₀ is set to 0.53.

### Example 1

This example is an example corresponding to the second embodiment.

As the lens surface molding surfaces 3a and 4a and the flat part molding surfaces 3b and 4b of the optical element molding die 2, release film parts 3m and 4m formed by sputtering at a weight ratio of 1:1 (Ir:Pt) with a film thickness of 1 μm were provided. L-LAH53 whose degree of basicity Λ(χ) was 0.55 was used as the glass G. The lens 1 was press-molded based on the method of manufacturing an optical element according to the second embodiment.

In the cleaning process, a surface of the glass G was cleaned using an organic solvent before it was arranged on the optical element molding die 2. Specifically, first, the surface of the glass G was cleaned with acetone, and was then cleaned with isopropyl alcohol.

As the removing process, the first removing process in which an oxygen concentration was set to 5 ppm or less was performed. Accordingly, the oxygen concentration in Step S was 5 ppm. Next, press-molding was performed while this oxygen concentration was maintained.

The lens 1 could be released from the optical element molding die 2 without causing seizing. No fogging was observed in the surface of the lens 1 after molding.

### Comparative Example 1

Comparative Example 1 was different from Example 1 in that the removing process in which the oxygen concentration was set to 5 ppm in Example 1 was not performed and press-molding was performed while the oxygen concentration was high at 100 ppm.

In this comparative example, the molded article was not able to be released. After the molded article was removed, when a surface of the release film was observed under a microscope, it was found that an adhesive material containing glass was observed on the surface of the release film and seizing had occurred.

### Example 2

Example 2 is an example corresponding to the first embodiment and is different from Example 1 in that L-BBH2 whose degree of basicity Λ(χ) was 0.45 was used as the glass G, the second removing process was performed in place of the first removing process as the removing process, and the oxygen concentration in the molding process was 10 ppm.

As the second removing process, as shown in FIG. 5, while the glass G was placed on the plate 24 made of alumina and accommodated in the glass Petri dish 23, a heat treatment was performed inside the heating furnace 20 under an air atmosphere A. A heating temperature was set to 300° C. and a heating time was set to 30 minutes.

After the heat treatment was performed, the glass G was accommodated in the optical element molding die 2 and a molding process was performed by the molding device 10.

The lens 1 was releasable from the optical element molding die 2 without causing seizing. No fogging was observed on the surface of the lens 1 after molding.

### Examples 3 and 4

Example 3 was performed in the same manner as Example 2 except that L-BBH1 whose degree of basicity Λ(χ) was 0.47 was used as the glass G and the lens 1 was molded.

Example 4 was performed in the same manner as Example 2 except that MP-200 whose degree of basicity Λ(χ) was 0.44 was used as the glass G and the lens 1 was molded.

In both of these two examples, the lens 1 was releasable from the optical element molding die 2 without causing seizing. No fogging was observed on the surface of the lens 1 after molding.

### Comparative Examples 2 to 4

Comparative Examples 2 to 4 were different from Examples 2 to 4 in that press-molding was performed without performing the removing process in Examples 2 to 4.

In Comparative Examples 2 to 4, the lens 1 was releasable from the optical element molding die 2 without causing seizing.

However, fogging occurred on surfaces of the lenses 1 after molding.

The degree of fogging of the molded article was worse in the order of Comparative Examples 4, 2, and 3. As the degree of basicity decreased, the degree of fogging worsened.

Based on the results of the examples and the comparative examples, it was found that defects such as seizing or fogging occurred on the lens 1 after molding when the removing process was not performed as in the comparative examples.

When degrees of basicity of the glass G of the comparative examples were separately examined, defects due to an oxidizing substance occurred at 0.55 (Comparative Example 1), and defects due to a basic substance occurred at 0.47 (Comparative Example 3), 0.45 (Comparative Example 2), and 0.44 (Comparative Example 4).

On the other hand, in Examples 1 to 4, a degree of basicity of the glass G was compared with a reference value. When the degree of basicity was the reference value or more, the first removing process was performed. When the degree of basicity was the reference value or less, the second removing process was performed. Therefore, it was possible to minimize defects due to a residual substance.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A process deciding method in a method of manufacturing an optical element by heating and press-molding an optical material to mold the optical element using a molding die on which a release film is formed, comprising:
a basicity degree identifying process in which a degree of basicity of the optical material is identified; and
a removing process determining process of determining whether to perform one or both of a first removing process in which an oxidizing substance is removed and a second removing process in which a basic substance is removed from at least one of a surface of the optical material and a surface of the release film by comparing the degree of basicity of the optical material identified in the basicity degree identifying process with a predetermined reference value, before pressing the optical material.

2. A process deciding method in a method of manufacturing an optical element by heating and press-molding an optical material to mold the optical element using a molding die on which a release film is formed, comprising:
a basicity degree identifying process in which a degree of basicity of the optical material is identified; and
a removing process determining process of determining whether to perform one or both of a first removing process in which any of oxygen, ozone, fluorine, chlorine, bromine, and a manganese oxide is removed and a second removing process in which any of carbon, a carbon compound, aluminum, and an alkali metal is removed from at least one of a surface of the optical material and a surface of the release film by comparing the degree of basicity of the optical material identified in the basicity degree identifying process with a predetermined reference value, before press-molding the optical material.

3. The process deciding method in the method of manufacturing an optical element according to claim 1, wherein in the removing process determining process, the reference value is set to 0.53, and the first removing process is determined to be performed when the degree of basicity of the optical material is equal to or more than the reference value, and the second removing process is determined to be performed when the degree of basicity of the optical material is equal to or less than the reference value.

4. The process deciding method in the method of manufacturing an optical element according to claim 2, wherein in the removing process determining process, the reference value is set to 0.53, and the first removing process is determined to be performed when the degree of basicity of the optical material is equal to or more than the reference value, and the second removing process is determined to be performed when the degree of basicity of the optical material is equal to or less than the reference value.

5. A method of manufacturing an optical element by molding an optical material whose degree of basicity is equal to or less than 0.53 using a molding die on which a release film is formed, comprising:
a removing process in which a basic substance is removed from at least one of a surface of the optical material and a surface of the release film; and
a molding process in which the optical material is arranged on the molding die and is heated and press-molded.

6. The method of manufacturing an optical element according to claim 5,
wherein a cleaning process in which at least one of surfaces of the optical material and the release film is cleaned using an organic solvent is performed before the removing process is performed, and
wherein the removing process includes a process in which residues of the organic solvent are removed.

7. A method of manufacturing an optical element by molding an optical material whose degree of basicity is equal to or more than 0.53 using a molding die on which a release film is formed, comprising:
a removing process in which an oxidizing substance is removed from at least one of a surface of the optical material and a surface of the release film; and
a molding process in which the optical material is arranged on the molding die to be heated and press-molded.

8. The method of manufacturing an optical element according to claim 7,
wherein the removing process includes a process of removing oxygen from surfaces of the optical material and the release film by setting an oxygen concentration in an atmosphere inside the molding die is set to equal to or less than 5 ppm, after the optical material is arranged on the molding die.

9. An optical element manufactured by the method of manufacturing an optical element according to claim 5.

10. An optical element manufactured by the method of manufacturing an optical element according to claim 7.
